(19) United States
(12) Patent Application Publication
(10) Pub. No.: US 2008/0288458 A1
(43) Pub. Date: Nov. 20, 2008

(54) Session Initiation Protocol (Sip) Multicast Management Method

(75) Inventors: Sheng Sun, Kanata (CA); Bing Wen, Ottawa (CA); Eric Wu, Ottawa (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: NORTEL NETWORKS LIMITED, St. Laurent, QC (CA)

(21) Appl. No.: 12/094,623

(22) PCT Filed: Dec. 8, 2005
(86) PCT No.: PCT/US05/44309

§ 371 Date: May 22, 2008

(51) Int. Cl. G06F 17/30; G06F 15/173

(52) U.S. Cl. 707/3; 709/231; 707/E17.014

(57) ABSTRACT

Described are a method and system for obtaining real-time media content over an Internet Protocol network. A proxy server receives a message from a client device requesting that communications be established with a media server for obtaining a stream of media content. The proxy server sends the client device a redirection message in reply to the client device if the requested media content is available from a local replication point. The redirection message instructs the client device to communicate with the local replication point to obtain the stream of media content.

### FIELD OF THE INVENTION

The invention relates generally to distributing multimedia content to subscribers over an Internet Protocol (IP) network. More specifically, the invention relates to the distribution of multicast multimedia applications using a point-to-point control signaling protocol.

### BACKGROUND

Current expectations are for the number of subscribers to broadband entertainment services, such as Internet Protocol Television (IPTV), to grow briskly. IPTV is a system in which broadband service providers distribute digital broadcast television over broadband connections using the Internet Protocol (IP). Presently, IP multicasting is a typical mechanism by which the service providers transport IPTV streams (i.e., channels) through the network. A commonly used multicasting protocol for switching channels is IGMP (Internet Group Management Protocol).

Another protocol gaining popularity for use with multimedia applications is the Session Initiation Protocol (SIP). Many service providers consider SIP to be the control signaling protocol of choice for multimedia applications because of its flexibility and extensibility. A current trend is to combine SIP sessions with IGMP processes for implementing channel changes.

Among subscribers of IPTV, however, the expectation for quality of experience (QoE) is high. Therefore, any solution that involves SIP needs to compete with the quality of experience currently enjoyed by subscribers of regular cable and satellite television. For IPTV to compete with such existing television services, any delay experienced during channel changing needs to be minimal. The point-to-point nature of SIP and the potentially large volume of simultaneous channel-change requests from subscribers, however, can severely affect the performance of the IPTV system, particularly if each channel change results in tearing down and setting up a chain of SIP sessions and IGMP processes. Hence, while there are incentives to use SIP for multicast-based multimedia applications over broadband connections, certain aspects of the protocol resist its wholesale adoption.

### SUMMARY

In one aspect, the invention features a method of obtaining real-time media content over an Internet Protocol network. A proxy server receives a message from a client device requesting that communications be established with a media server for obtaining a stream of media content. The proxy server sends the client device a redirection message in reply to the message from the client device if the requested media content is available from a local replication point. The redirection message instructs the client device to communicate with the local replication point to obtain the stream of media content.

In another aspect, the invention features a network for distributing real-time media content. The network comprises a media server, a local replication point in communication with the media server, and a proxy server in communication with a client device. The proxy server receives a message from the client device requesting that communications be established with the media server for obtaining a particular stream of media content. The proxy server sends to the client device a redirection message in reply to the message from the client device if the requested media content is available at the local replication point. The redirection message instructs the client device to establish communications with the local replication point to obtain the particular stream of media content.

In still another aspect, the invention features a network device having a proxy agent in communication with a client device over an access network. The proxy agent receives a message from the client device requesting that communications be established with a media server for obtaining a stream of media content. The proxy agent sends to the client device a redirection message in reply to the message from the client device if the media content is available from a cache server. The redirection message instructs the client device to communicate with the cache server to obtain the requested stream of media content.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an exemplary networking environment in which aspects of the invention may be implemented.

FIG. 2 is a block diagram of a portion of the networking environment of FIG. 1, including a client device, a proxy server, a local replication point, location servers, and a media server.

FIG. 3 is a flow diagram of an embodiment of a process for forwarding a request from the client device to the media server to obtain media content in accordance with the invention.

FIG. 4 is a block diagram of the portion of the networking environment shown in FIG. 2, in which the media server responds to the request from the client device.

FIG. 5 is a flow diagram of an embodiment of a process for responding to the request from the client device in accordance with the invention.

FIG. 6 is a block diagram of the portion of the networking environment shown in FIG. 1, in which the proxy server redirects a second client device to the local replication point for obtaining the same media content requested previously and stored at the local replication point.

FIG. 7 is a flow diagram of an embodiment of a process for redirecting the request from the second client device (FIG. 6) to the local replication point in accordance with the invention.

### DETAILED DESCRIPTION

Systems and methods embodying the present invention can achieve real-time distribution of multimedia content to multiple concurrent subscribers over an Internet Protocol (IP) network without the use of a multicasting protocol, such as IGMP (Internet Group Management Protocol). As described herein, client devices and servers communicate using a point-to-point signaling protocol, exemplified by the session initiation protocol (SIP), to request, locate, deliver, and receive multimedia content over the IP network. Internet Protocol Television (IPTV) is as an example of a real-time multimedia application that can benefit from the practice of the invention, and is used herein to illustrate the invention's principles.

An IPTV system can expect to have many concurrent viewers, with each viewer having many broadcast TV channels from which to choose. In some IPTV systems, only channels selected by a viewer are distributed to the customer premises. Many TV channels enjoy multiple concurrent viewers. Such channels are thus distributed to multiple customer premises. In accordance with the invention, the first time any subscriber selects a given channel, a request for the channel content passes from that subscriber (i.e., a client device) to the media source. In response, the media source delivers, or causes delivery of, the corresponding content to a cache server (also referred to hereafter as a replication point), from which the subscriber obtains the content.

Upon a subsequent selection of that channel by a second subscriber, a proxy redirects the second subscriber to obtain the content from the replication point. The replication point is already receiving the desired content because of the initial request by the first subscriber. Consequently, the second subscriber (i.e., its client device) does not need to establish communications with the media source to receive the channel content. To support this redirection mechanism, one embodiment of the invention enhances the session initial protocol, as defined in RFC 3261, with a new redirection method. The entirety of RFC 3261, titled “SIP: Session Initiation Protocol”, is incorporated by reference herein. The new redirection method includes a type number (any number within the range of 300 to 400 (e.g., 310), provided the number is not a duplicate of existing redirection types) and includes an address of the replication point (e.g., in a Contact field or message body) to be used by the second subscriber to obtain the requested content.

Because of the redirection mechanism, the use of a native multicast protocol becomes unnecessary: instead, each redirected subscriber can establish a point-to-point communication path with the replication point to obtain the “cached” content. In addition, the distribution of content through redirection scales with an increase in the number of concurrent subscribers, reduces network traffic at the media source, and removes the media source as a single point of failure. Further, the redirection mechanism can, as described in more detail below, achieve sufficiently rapid channel changes so as not to offend the user experience.

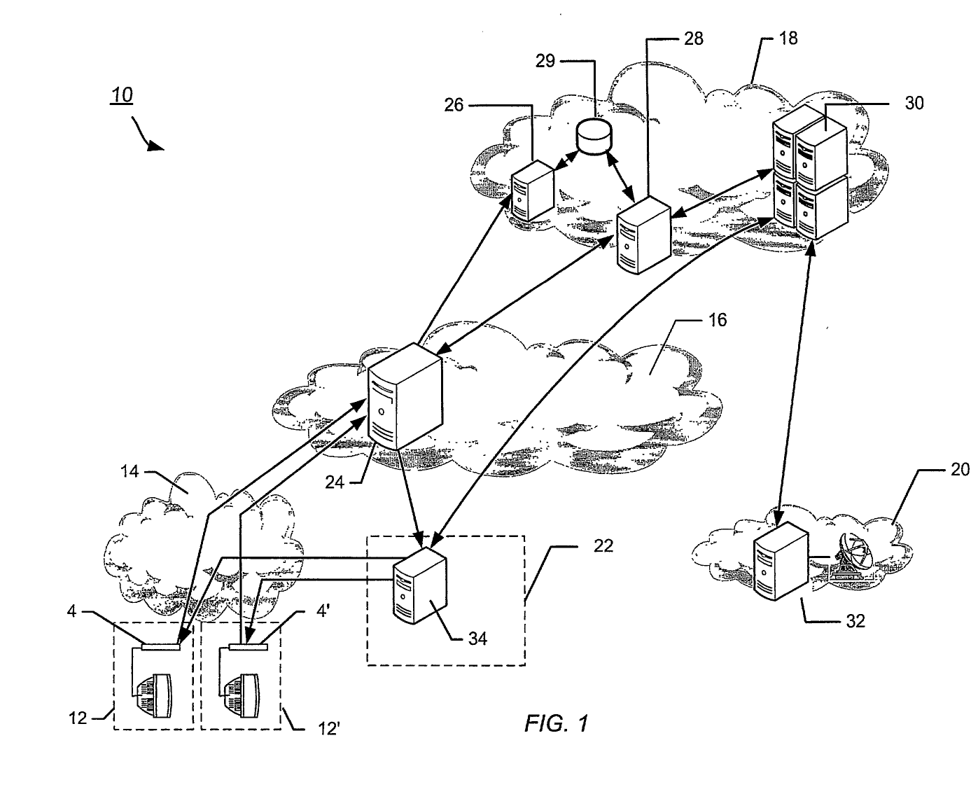

FIG. 1 shows an embodiment of a networking environment 10 in which the invention may be practiced. The networking environment 10 includes home networks 12, 12′, an access network 14, a core IP network 16, an administration network 18, a video head-end network 20, and a central office 22. The various networks of the networking environment 10 cooperate to distribute real-time multimedia content to subscribers. This description illustrates the principles of the invention as applied to the delivery of TV channels to subscribers of digital broadcast television services (i.e., IPTV). It is to be understood that the principles of the invention can extend to other media-delivery applications, e.g., voice over IP (VoIP), video-on-demand (VoD).

The home networks 12, 12′ reside on customer premises and include customer equipment, such as set-top boxes, personal computers, routers, modems, etc. In general, home networks can have a variety of topologies and customer equipment. For simplicity of illustration, each home network 12, 12′ is shown to have one set-top box 4, 4′, respectively, each coupled to a digital television set.

The set-top boxes 4, 4′, generally referred as client devices, operate as endpoints (i.e., broadband network termination) for terminating IPTV traffic. A session initiation protocol (SIP) user agent (UA) executes on each set-top box 4, 4′ for communicating with the proxy server 24 when requesting real-time multimedia content, as described herein. Through the set-top boxes 4, 4′ television viewers send requests that select and change channels. Channel changes issue from the set-top boxes 4, 4′ as SIP messages.

The access network 14 links the home networks 12, 12′ with the core IP network 16. Also referred to as the “last mile”, the access network 14 provides a broadband connection over which the home networks 12, 12′ can communicate with remote media (or content) servers to obtain multimedia content. Client devices can establish broadband connections through any one of a variety of technologies, an example of which is digital subscriber line (DSL). To support DSL, for example, the access network 14 includes one or more Digital Subscriber Line Access Multiplexers (DSLAMs) to aggregate DSL connections from multiple customers onto a single backbone line.

The managed IP core network 16, in general, provides the reliable and timely distribution of IPTV data streams from the media and content servers to the customer premises. The core network 16 can include an optical distribution backbone network. A proxy server 24 in the core network 16 serves the domain (or domains) of the client devices 4, 4′. Operating as an SIP server that provides a Proxy Call Session Control Function or P-CSCF, the proxy server 24 receives the SIP messages from the client devices 4, 4′ and forwards those messages on their behalf. Each client device 4, 4′ can be pre-configured (i.e., pre-programmed) with the address of the proxy server 24 to facilitate communications with the proxy server 24. Alternatively, the client devices 4, 4′ can discover the address of the proxy server 24, for example, by DHCP (Dynamic Host Configuration Protocol).

The administration network 18 includes SIP servers 26, 28, a home subscriber server (HSS) 29, and a media server 30 (a cluster of application servers). Although shown in FIG. 1 as separate nodes, the HSS and SIP servers can be implemented within a single node. The HSS 29 maintains a master user database containing user profiles. The HSS 29 can perform authentication and authorization and provide information about the physical location of the user.

The SIP servers 26, 28 are in communication with the HSS 29 to obtain the user location information (user profiles). In general, the SIP server 26 provides an Interrogating Call Session Control Function (or I-CSCF) and the SIP server 28 provides a Serving Call Session Control Function (or S-CSCF). The proxy server 24 is in communication with the I-CSCF server to identify a target S-CSCF server for forwarding a given SIP message. The S-CSCF server 28 identifies service privileges of users and determines to which application server of the media server 30 to forward the given SIP message. The media server 30 sources the multimedia content (i.e., broadcast IPTV channels) to be delivered to the home networks 12, 12′. Typically, one IPTV data stream traverses the core IP network 16 for each channel of programming. The central office 22 includes a local replication point 34 for receiving the IPTV data streams, as described in more detail below. (Referral to the replication point as local illustrates that the preferred geographical deployment of the replication point is within vicinity of the customer premises equipment. In general, replication points—there can be more than one—are collocated with the proxy server at the local central office).

The video head-end network 20 includes a content server 32 for receiving streams of programming, e.g., via satellite directly from a broadcaster (or programmer) or from an aggregator. The content server 32 obtains each individual channel of programming, encodes its multimedia content into a digital video format, and stores the content in a database. The media server 30 is in communication with the content server 32 to direct the delivery of the multimedia content from the content server 32 to the replication point at the central office.

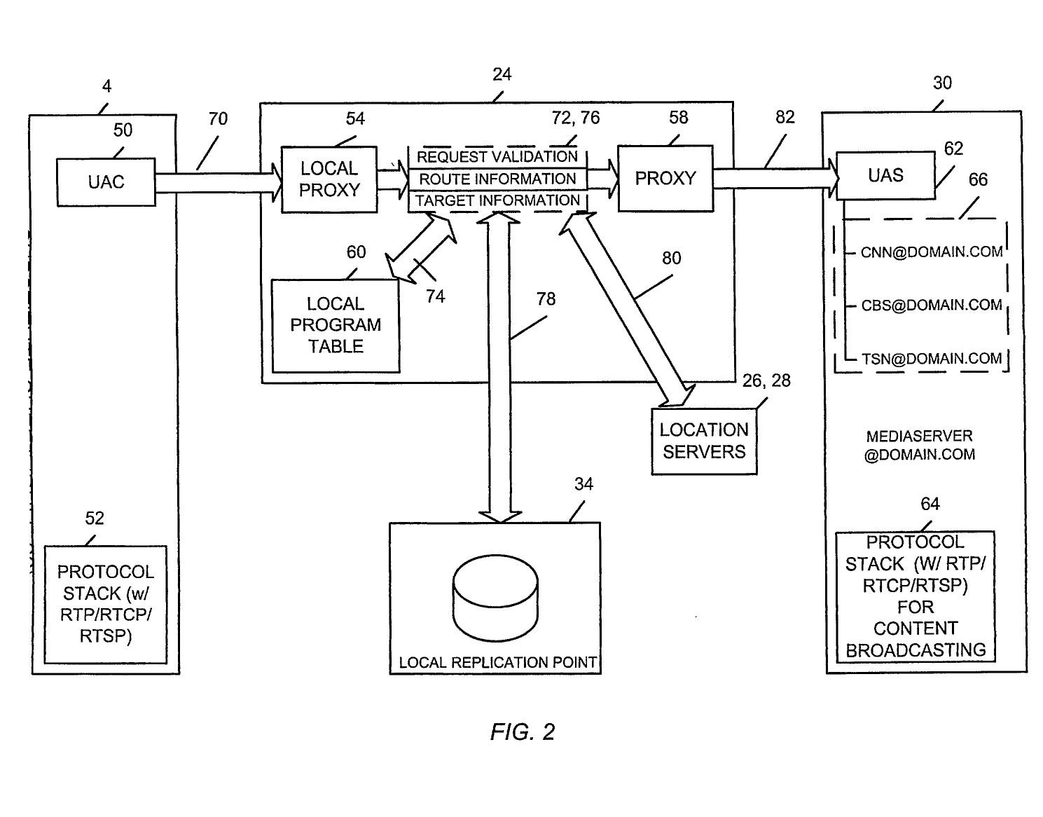

FIG. 2 shows a portion of the networking environment 10 of FIG. 1, including one of the client devices 4, the proxy server 24, the local replication point 34, location servers 26, 28, and the media server 30. The client device 4 includes user agent client (UAC) software 50 and a protocol stack 52 having RTP (Real-Time Transport Protocol), RTCP (Real-Time Transport Control Protocol), and RTSP (Real-Time Transport Streaming Protocol) procedures for establishing a communication path by which to receive audio and video data over an IP network.

The media server 30 includes user agent server (UAS) software 62 and a protocol stack 64 having RTP, RTCP, and RTSP procedures for broadcasting content over the IP network. In general, the content server 32 includes the protocol stack 64, and the media server 30 instructs the content server 32 to establish an RTP with the replication point 34—here, though, the protocol stack 64 is shown to be part of the media server 30 to simplify the illustration. Associated with the media server 30 is a Uniform Resource Identifier (URI), e.g., mediaserver@domain.com. A database 66 maintains a list of the channels available at the media server 30 (e.g., CNN@domain.com, CBS@domain.com, and TSN@domain.com).

The proxy server 24 includes local proxy code 54 for communicating with the UAC 50 of the client device 4 and proxy code 58 for communicating with the UAS of the media server 30. To handles requests from the UAC 50, the configuration of the proxy server 24 is set to Stateful, which configures the proxy server 24 as an SIP transaction-processing engine. In addition, the proxy server 24 includes a local program table 60 (i.e., a database) for recording entries representing those channels for which the local replication point 34 is presently storing content. For each table entry, the local program table 60 also indicates whether that entry is active or expired. An active status indicates that the IPTV stream corresponding to the associated channel is available at the local replication point 34. An expired status indicates that the time for viewing the content of the associated channel has passed and, thus, the content is unavailable.

In brief overview, the distribution of real-time multimedia content to a client device can be considered to occur in phases: a forwarding phase, a response phase, and a redirection phase. Which of these phases occurs for a given request depends upon whether the client device requesting an IPTV channel is the first requester of that IPTV channel or a subsequent requester.

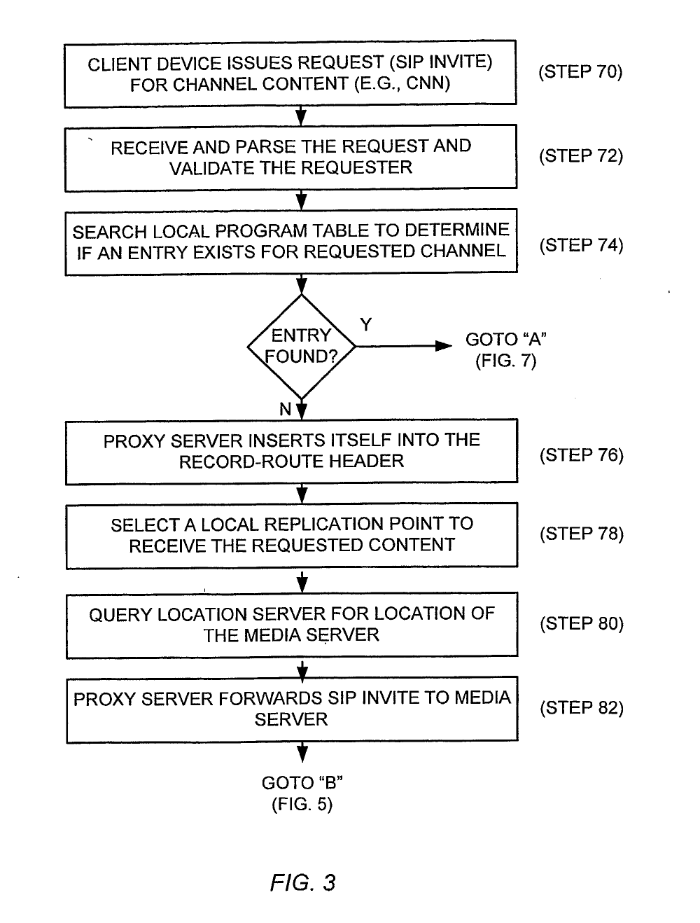

FIG. 3 shows an embodiment of a forwarding phase in which the client device 4 sends a request to the media server 30 to obtain real-time multimedia content using SIP. In the description of the forwarding phase, reference is also made to FIG. 1 and FIG. 2. At step 70, the user of client device 4 selects a channel (e.g., CNN) and the UAC 50 of the client device 4 (here, a set-top box) sends an SIP INVITE request through the access network 14 to the proxy server 24. The SIP INVITE request is one type of an SIP method that specifies a particular action that the client device 4 wants the media server 30 to perform, namely, to obtain the content of a specified channel. The SIP INVITE request includes a plurality of header fields, a request line, and a timestamp. The header fields include: To, From, and CSeq (Command Sequence). The To field contains a SIP URI towards which the request is originally directed, the From field contains a SIP URI of the originating client device, and the Cseq contains an integer value that is incremented for each request within a SIP dialog.

The request line includes the SIP method (e.g., INVITE) and the request-URI. The request-URI identifies the UAS that is to process the request. In an SIP INVITE request, the request-URI can be the URI of the target channel, or, preferably, the URI of the media server 30. Specifying the URI of the media server 30 as the request-URI is more advantageous than specifying the URI of the target channel.

For instance, if the client device 4 establishes an SIP session with a target channel, a request to change the channel requires terminating this session with the target channel and establishing a new session with a new target channel. This terminating and reestablishing can delay the channel-changing process. In contrast, if the client device 4 establishes an SIP session with the media server 30, then a request to change channels is communicated within the dialog of the existing session. The session with the media server 30 persists across the channel change—there is no termination of the existing session. Consequently, channel changes do not incur the delay associated with terminating and reestablishing sessions.

To facilitate communication with the media server 30, the UAC 50 of the client device 4 can be pre-programmed to include the SIP URI of the media server 30 in the Request-URI of the INVITE request. When the request-URI specifies the URI of the media server 30, the payload of the SIP INVITE carries the URI of the target channel.

At step 72, the local proxy 54 receives and parses the SIP INVITE request and determines if the requester is valid (authentication and authorization) by communicating with the location servers 26, 28. At step 74, the proxy server 24 searches the local program table 60 to determine if an entry exists for the requested channel. If an entry is not found (i.e., this is the first request for this particular channel), the proxy server 24 adds (step 76) itself to the Record-Route header of the SIP INVITE request. By inserting its address into the Record-Route header, the proxy server 24 causes the routing of future requests in the dialog to pass through the proxy server 24.

In addition, the proxy server 24 selects (step 78) a local replication point 34 to operate as proxy for receiving the requested content from the media server 30. (Multiple local replication points 34 may be available to the proxy server 24, from which the proxy server 24 selects one to receive the content. The proxy server 24 can maintain a database with entries representing these local replication points 34). The selection may be arbitrary or predetermined. The address of the selected local replication point 34 becomes part of the INVITE request—the proxy server 24 adds the address of the selected local replication point 34 to the INVITE request.

The proxy server 24 also communicates with the location servers 26, 28 to determine (step 80) the URI of the media server 30 that is to receive the request. (The URI of the media server 30 used by the client device 4 is generic. From the generic URI, the location servers 26, 28 mediate and resolve the generic URI to the particular server in the cluster. Each media server has its own unique URI so that sessions can be established with a given media server that persists across multiple channel changes). The location servers 26, 28 maintain updated information indicating which server in the cluster of media servers 30 services what channels and which of the media servers is best able to supply the requested content. The location servers 26, 28 respond to the proxy server 24 with the URI of this particular media server. The proxy server 24 replaces the original destination URI with the URI of the resolved media server. At step 82, the proxy server 24 forwards the INVITE request to the resolved media server 30.

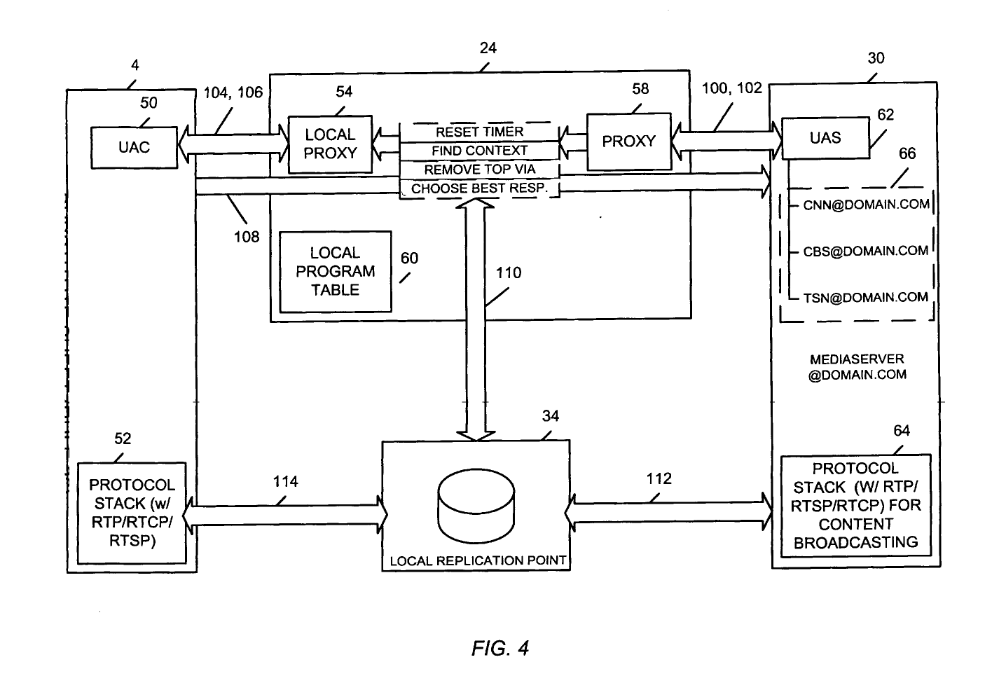

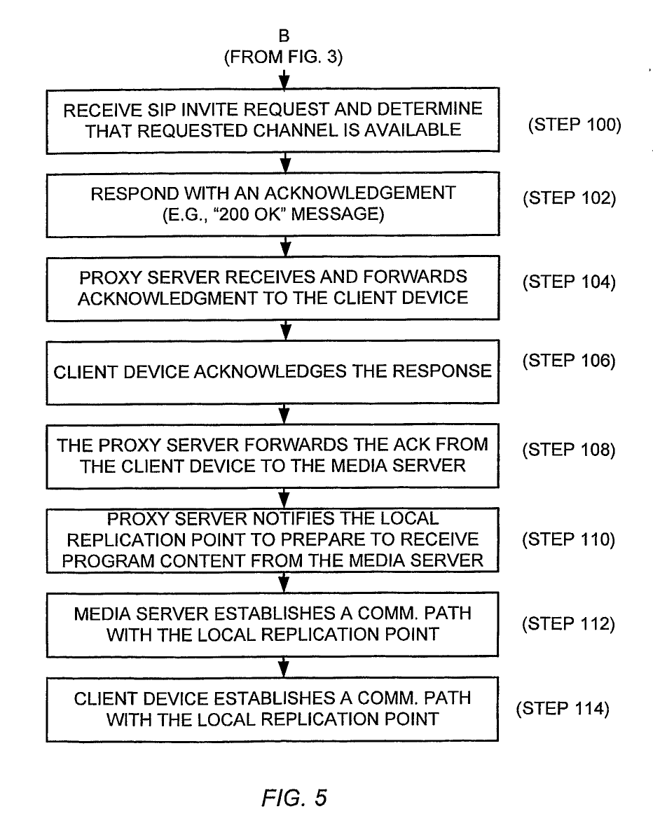

FIG. 4 and FIG. 5 illustrate an embodiment of a response phase, in which the media server 30 responds to the INVITE request from the client device 4. At step 100, the UAS 62 of the media server 30 receives the INVITE request and determines whether the requested channel is available. If the channel is available, at step 102 the media server 30 responds with an acknowledgement, e.g., a SIP “200 OK” message, indicating that the media server 30 is ready to accept the request and to send the stream of content to the local replication point 34. The “200 OK” message operates to establish a dialog. The media server 30 also includes a Session Description Protocol (SDP) message identifying the type of content to be sent.

At step 104, the proxy server 24 receives and forwards this acknowledgement to the client device 4, along with the address of the local replication point 34. The UAC 50 of the client device 4 determines whether to accept this response by checking the Cseq value (to ensure that the acknowledgement corresponds to the INVITE request) and to compare its timestamp (to ensure that the response is timely). Upon accepting the acknowledgment, the client device 4 responds (step 106) to the proxy server 24 with an acknowledgement. In addition, the client device 4 consequently knows to communicate with the local replication point 34 to receive the requested programming content.

At step 108, the proxy server 24 forwards the acknowledgement from the client device 4 to the media server 30. The proxy server 24 also communicates (step 110) with the selected local replication point 34 to prepare the local replication point 34 for receiving content from the media server 30. These communications include the identity (i.e., URI) of the client device 4 requesting the service, for use by the local replication point 34 when the client device 4 attempts to establish communications therewith.

At step 112, the media server 30 establishes a communication path with the local replication point 34 using one or more real-time protocols (i.e., RTP, RTSP, RTCP). Over this communication path, the channel content passes from the media server 30 to the local replication point 34. At step 114, the client device 4 establishes a communication path with the local replication point 34 using one or more real-time transport protocols (i.e., RTP, RTSP, RTCP). After establishment of this communication path, the client device 4 receives the requested channel content from the local replication point 34.

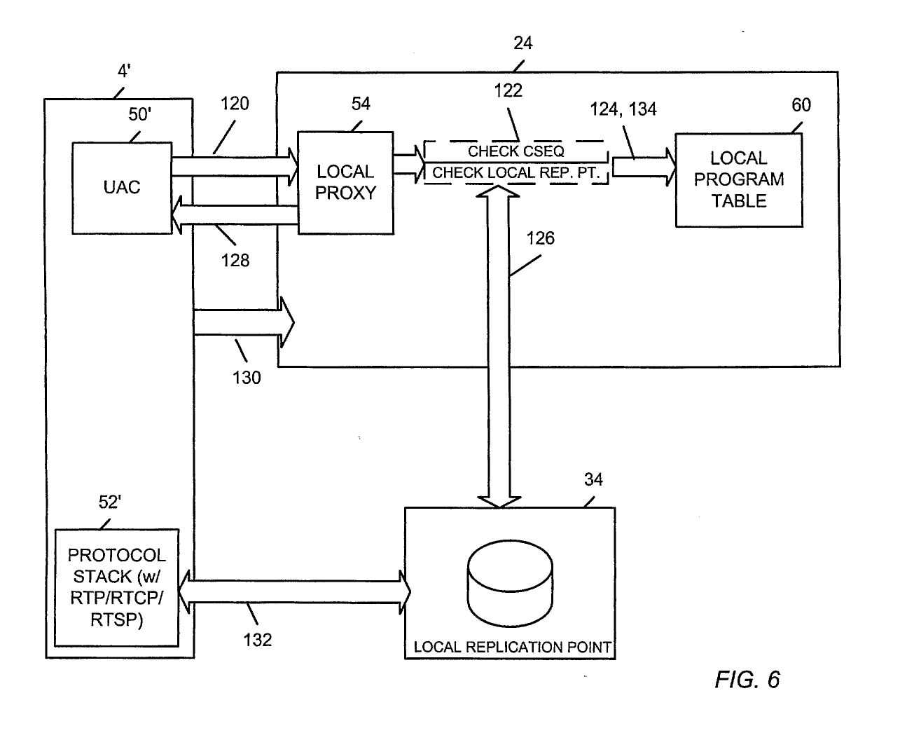

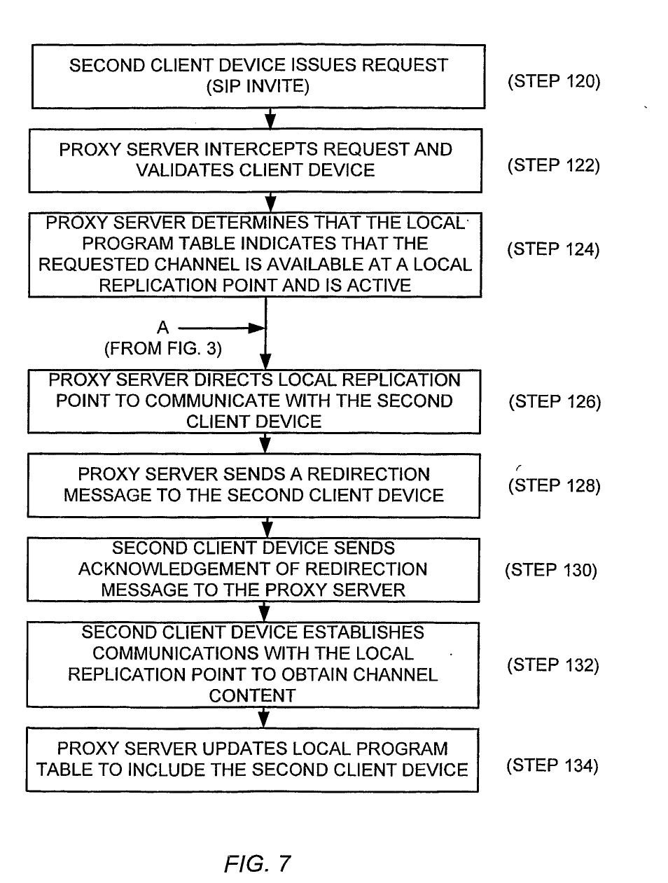

FIG. 6 and FIG. 7 illustrate an embodiment of a redirection phase, in which the proxy server 24 sends a Redirection message to the client device 4′ in response to an INVITE request for content currently cached and available in the local replication point 34. At step 120, the user of the client device 4′ selects a channel, causing the UAC 50′ of the client device 4′ to send an SIP Invite request over the access network 14 to the proxy server 24. The proxy server 24 intercepts the request and validates (step 122) the requester. When the requester passes validation, the proxy server 24 determines (step 124) from the local program table 60 that the programming content associated with the channel requested by the client device 4′ is presently available at the local replication point 34. (For example, the second client device 4′ has selected the same channel as the first client device 4 in FIG. 5). In addition, the proxy server 24 also determines that the content at the local replication point 34 is active (not expired).

If the requested content is available, the proxy server 24 communicates (step 126) with the local replication point 34 to update a database at the local replication point 34. The update informs the local replication point 34 to communicate with the client device 4′ for transmission of the requested content. If the content is instead flagged as expired, or if no entry exists in the local program table 60 for the requested channel, the proxy server 24 forwards the INVITE request to the media server 30, as described in FIGS. 2 and 3.

After determining that the content can be obtained from the local replication point 34, the proxy server 24 sends (step 128) an SIP redirection message to the client device 4′. The redirection message directs the client device 4′ to communicate with the local replication point 34 to obtain the desired programming content. An SDP message in the body of the redirection message identifies the local replication point 34 to which the proxy server 24 is redirecting the client device 4′.

At step 130, the UAC 50′ of the client device 4′ acknowledges the redirection message. Before acknowledging the redirection message, the UAC 50′ confirms that the response from the proxy server 24 is valid and timely (by checking the Cseq and timestamp). At step 132, the client device 4′ establishes a communication path with the local replication point 34 using one or more real-time transport protocols. After establishing this path, the client device 4′ commences receiving the content from the local replication point 34. The proxy server 24 also updates (step 134) its local program table 60 to include the identity of the second client device 4′ (i.e., the identity of the most recent requester of the channel). An associated Timer is also reset. The timer ensures that there are always viewers associated with a particular program. In the event of abnormal termination, the proxy server 24 uses the timer to expire the program.

Providers of IPTV services can expect to have numerous subscribers concurrently requesting channels from their channel listings. Eventually, many, if not all, IPTV channels offered by a given provider (for a given time slot—e.g., 8-PM to 9-PM) may become cached at one or more local replication points because of the small number of channels offered by the provider compared to the number of subscribers navigating through these channels. After the local replication points become populated with the various channels, it is expected that many subsequent INVITE requests during this time slot would result in a redirection to a local replication point.

Although the invention has been shown and described with reference to specific preferred embodiments, it should be understood by those skilled in the art that various changes in form and detail may be made therein without departing from the spirit and scope of the invention as defined by the following claims. For example, in the previously described embodiments, for media content to become cached at a local replication point requires a first requester: that is, one subscriber issues a request for a channel that becomes forwarded to the media server and then the content of that channel is cached at the local replication point. In an alternative embodiment, the local replication point is proactively filled with media content. That is, rather than wait for a first requester, the local replication point can communicate with the media server to download channels proactively in anticipation of expected demand. Thus, when a first requester for a particular channel issues a request, the proxy server can immediately employ the redirection mechanism described above to direct the first requester to the local replication server.

What is claimed is:

1. A method of obtaining real-time media content over an Internet Protocol network, the method comprising:
receiving at a proxy server a message from a client device, the message requesting that communications be established with a media server for obtaining a stream of media content; and
sending from the proxy server to the client device a redirection message in reply to the message from the client device if the requested media content is available from a local replication point, the redirection message instructing the client device to communicate with the local replication point to obtain the stream of media content.

2. The method of claim 1, further comprising the steps of:
forwarding by the proxy server to the media server the message from the client device if the media content is unavailable from the local replication point;
instructing the media server to transmit the stream of media content to the local replication point; and
instructing the client device to communicate with the local replication point to obtain the stream of media content.

3. The method of claim 1, further comprising the step of searching, by the proxy server, a database to determine that the requested media content is stored at the local replication point.

4. The method of claim 3, further comprising the step of determining whether the requested media content stored at the local replication point has expired.

5. The method of claim 1, wherein messages exchanged between the client device and proxy server and between the proxy server and the media server are session initiation protocol (SIP) messages.

6. The method of claim 1, further comprising the step of establishing an SIP session between the client device and the media server that persists across multiple requests from the client device to obtain different streams of media content.

7. A network for distributing real-time media content, comprising:
a media server;
a local replication point in communication with the media server;
a proxy server in communication with a client device, the proxy server receiving a message from the client device requesting that communications be established with the media server for obtaining a particular stream of media content, the proxy server sending to the client device a redirection message in reply to the message from the client device if the requested media content is available at the local replication point, the redirection message instructing the client device to establish communications with the local replication point to obtain the particular stream of media content.

8. The network of claim 7, wherein:
the proxy server is in communication with the media server to forward the message from the client device if the media content is unavailable from the local replication point;
the media server is in communication with the local replication point to transmit the particular stream of media content to the local replication point in response to the forwarded message from the client device; and
the local replication point is in communication with the client device to deliver the particular stream of media content thereto.

9. The network of claim 7, wherein the proxy server includes a database with one or more entries, each entry identifying a different stream of media content stored at the local replication point.

10. The network of claim 9, wherein each entry of the database indicates whether the media content identified by that entry has expired.

11. The network of claim 7, wherein the messages exchanged between the client device and the proxy server and between the proxy server and media server are session initiation protocol (SIP) messages.

12. The network of claim 7, wherein the client device establishes an SIP session with the media server that persists across multiple requests from the client device to obtain different streams of media content.

13. The network of claim 7, Wherein a request from the client device for a different stream of media content occurs within a dialog portion of the SIP session.

14. The network of claim 7, wherein the message from the client device includes a universal resource identifier of the media server and a universal resource identifier of the requested stream of media content.

15. A network device comprising a proxy agent in communication with a client device over an access network, the proxy agent receiving a message from the client device requesting that communications be established with a media server for obtaining a stream of media content, the proxy agent sending to the client device a redirection message in reply to the message from the client device if the media content is available from a cache server, the redirection message instructing the client device to communicate with the cache server to obtain the requested stream of media content.

16. The network device of claim 15, further comprising a database with one or more entries, each entry identifying media content stored at the cache server.

17. The network device of claim 16, wherein each entry of the database indicates whether the media content identified by that entry has expired.

18. The network device of claim 15, wherein the proxy agent (1) forwards to the media server the message from the client device if the requested media content is unavailable at the cache server, and (2) instructs the media server to transmit the requested stream of media content to the cache server.

19. The network device of claim 15, wherein the messages exchanged between the client device and the proxy agent are session initiation protocol (SIP) messages.

20. The network device of claim 15, wherein redirection message sent to the client device specifies an address of the cache server.
